(19) United States
(12) Patent Application Publication
(10) Pub. No.: US 2023/0078662 A1
(43) Pub. Date: Mar. 16, 2023

(54) FIBER-REINFORCED COMPOSITE MATERIAL AND METHOD OF MANUFACTURING SAME

(71) Applicants: HYUNDAI MOTOR COMPANY, Seoul (KR); KIA CORPORATION, Seoul (KR)

(72) Inventor: Young Ho Choi, Seongnam-si (KR)

(73) Assignees: HYUNDAI MOTOR COMPANY, Seoul (KR); KIA CORPORATION, Seoul (KR)

(21) Appl. No.: 17/902,069

(22) Filed: Sep. 2, 2022

(30) Foreign Application Priority Data
Sep. 6, 2021 (KR) 10-2021-0118132

(51) Int. Cl. B29C 70/22; D03D 15/283; D03D 13/00; D03D 15/37

(52) U.S. Cl. CPC B29C 70/22; D03D 15/283; D03D 13/008; D03D 15/37; B29K 2105/0845

(57) ABSTRACT

A fiber-reinforced composite material and a method of manufacturing the fiber-reinforced composite material are disclosed. The fiber-reinforced composite material includes a fabric manufactured by weaving a weft including a synthetic fiber and a warp including a synthetic fiber, a carbon fiber, or a combination thereof, and a resin with which the fabric is impregnated and/or coated, wherein the resin includes urethane, urethane acrylate, urea, epoxy, acryl, polycarbonate, polymethyl methacrylate, polypropylene, polyvinyl chloride, polyvinyl butyral, or any combination thereof.

### CROSS-REFERENCE TO RELATED APPLICATION

This application claims under 35 U.S.C. § 119(a) the benefit of priority to Korean Patent Application No. 10-2021-0118132, filed on Sep. 6, 2021, the entire contents of which are incorporated herein by reference.

### BACKGROUND

### (a) Technical Field

The present disclosure relates to a fiber-reinforced composite material and a method of manufacturing the fiber-reinforced composite material. More particularly, the present disclosure relates to a fiber-reinforced composite material including a fabric manufactured by weaving a weft and a warp, and a resin with which the fabric is impregnated and/or coated, wherein the resin includes urethane, urethane acrylate, urea, epoxy, acryl, polycarbonate, polymethyl methacrylate, polypropylene, polyvinyl chloride, polyvinyl butyral, or any combination thereof.

### (b) Background Art

Carbon-fiber-reinforced plastic (CFRP) is being applied to aerospace, sports, and high-performance automotive structural parts due to the superior mechanical properties and low specific gravity thereof compared to metals. In order to take advantage of the high-grade and high-performance consumer perception of CFRP, CFRP has started to be applied to decorative parts for luxury cars.

However, when a carbon fiber fabric is used for simple decorative parts, rather than structural parts, a weft is moved using a special loom equipped with a mechanical grip in the process of weaving a decorative patterned fabric due to the brittleness of carbon fiber, and thus the rate of production is decreased, and many limitations are imposed thereon. Moreover, carbon fiber is heavy because the specific gravity of the carbon fiber is 1.8, which is higher than that of various synthetic fibers. Furthermore, it is difficult to realize various colors and there are many restrictions on the weave of the fabric depending on the shape of parts.

### SUMMARY OF THE DISCLOSURE

An object of the present disclosure is to provide a method of manufacturing a fiber-reinforced composite material, which is not limited with regard to weaving devices and for which the weaving speed may be increased.

Another object of the present disclosure is to provide a fiber-reinforced composite material having a low specific gravity, thereby being capable of lowering the weight of a molded article.

Still another object of the present disclosure is to provide a fiber-reinforced composite material capable of realizing various colors of fibers.

Yet another object of the present disclosure is to provide a fiber-reinforced composite material that is not limited with regard to the weave pattern of the fabric, regardless of the shape of parts.

The objects of the present disclosure are not limited to the foregoing. The objects of the present disclosure are able to be understood through the following description and to be realized by the means described in the claims and combinations thereof.

An embodiment of the present disclosure provides a fiber-reinforced composite material including a fabric woven with a warp and a weft and a resin applied to the fabric, in which the warp may include a synthetic fiber, a carbon fiber, or a combination thereof, and the weft may include a synthetic fiber.

The fabric may be weaved in any one of a plain weave, a twill weave, or a satin weave.

The synthetic fiber of the warp and/or the weft may include polyethylene terephthalate (PET), nylon, polypropylene (PP), acryl, or any combination thereof.

The resin may include urethane, urethane acrylate, urea, epoxy, acryl, polycarbonate, polymethyl methacrylate, polypropylene, polyvinyl chloride, polyvinyl butyral, or any combination thereof.

The resin may be applied by impregnating or coating the fabric.

The weaving density of the fabric may be in a range of 4 to 40 count/inch.

The shape of the cross-section of the synthetic fiber of the warp and/or the weft includes a circular shape, an oval shape, a polygonal shape, a flat shape, a multilobal shape, or any combination thereof.

The aspect ratio of the synthetic fiber having a flat cross-sectional shape may be in a range of 1:1.2 to 1:5.

Another embodiment of the present disclosure provides a method of manufacturing a fiber-reinforced composite material. The method includes manufacturing a fabric by weaving fibers, applying a resin to the fabric, and curing the resin applied to the fabric. The fabric may be manufactured by weaving fibers as a warp and a weft. The warp may include a synthetic fiber, a carbon fiber, or a combination thereof, and the weft may include a synthetic fiber.

The weaving speed may range from about 110 m/day or more.

The curing the resin may be performed for about 100 seconds or less.

### DETAILED DESCRIPTION

The above and other objects, features, and advantages of the present disclosure are further understood from the following embodiments taken in conjunction with the accompanying drawings. The present disclosure is not limited to the embodiments disclosed herein and may be modified into different forms. These embodiments are provided to thoroughly explain the disclosure and to sufficiently transfer the spirit of the present disclosure to those of ordinary skill in the art.

The terms “comprise,” “include,” “have,” etc., when used in this specification, specify the presence of stated features, integers, steps, operations, elements, components, or combinations thereof, but do not preclude the presence or addition of one or more other features, integers, steps, operations, elements, components, or combinations thereof. Also, when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

The present disclosure pertains to a fiber-reinforced composite material and a method of manufacturing the fiber-reinforced composite material. More particularly, the present disclosure pertains to a fiber-reinforced composite material including a fabric manufactured by weaving a weft including a synthetic fiber and a warp including a synthetic fiber, a carbon fiber, or a combination thereof, and a resin with which the fabric is impregnated and/or coated. The resin includes urethane, urethane acrylate, urea, epoxy, acryl, polycarbonate, polymethyl methacrylate, polypropylene, polyvinyl chloride, polyvinyl butyral, or any combination thereof.

### Method of Manufacturing Fiber-Reinforced Composite Material

The method of manufacturing the fiber-reinforced composite material includes manufacturing a fabric by weaving fibers, applying a resin to the fabric, and curing the resin applied to the fabric.

### Manufacturing Fabric

A fabric is manufactured by weaving fibers.

The fabric may be manufactured by weaving fibers in the form of a warp and a weft.

The weaving density of the fabric may be in a range of 4 to 40 count/inch. Here, if the weaving density thereof is less than 4 count/inch, the number of yarns per unit length is low, forming a pattern with a large warp and weft width, and the pattern is larger than that of tuning parts for vehicles, which deteriorates aesthetics. On the other hand, if the weaving density thereof exceeds 40 count/inch, there are too many warp/weft yarns per unit length, making it difficult to recognize the unique pattern of the carbon fabric.

The weaving speed may be 100 m/day or more.

The fabric may be woven in any one of a plain weave, a twill weave, or a satin weave using the warp and weft.

The warp includes a synthetic fiber, a carbon fiber, or a combination thereof.

The weft includes a synthetic fiber.

The cross-section of the synthetic fiber of the warp and/or the weft has at least one shape selected from among a circular shape, an oval shape, a polygonal shape, a flat shape, and a multilobal shape. The flat shape may refer to a rectangular shape elongated in any one direction. The multilobal shape may refer to a fiber shape characterized by a large number of leaves. The multilobal shape may include a trilobal shape, a pentalobal shape, an octolobal shape, or any combination thereof.

The aspect ratio of the synthetic fiber having a flat shape of the cross-section may be in a range of 1:1.2 to 1:5. Here, if the aspect ratio thereof is less than 1:1.2, the three-dimensional (3D) patterning effect is the same as a circular shape, whereas if the aspect ratio thereof exceeds 1:5, the outer appearance may be deteriorated due to fiber kinking.

The synthetic fiber of the warp and/or the weft includes polyethylene terephthalate (PET), nylon, polypropylene (PP), acryl, or any combination thereof.

### Applying Resin

A resin is applied to the fabric. More specifically, the resin is applied by impregnating and/or coating the fabric therewith.

The resin includes urethane, urethane acrylate, urea, epoxy, acryl, polycarbonate, polymethyl methacrylate, polypropylene, polyvinyl chloride, polyvinyl butyral, or any combination thereof.

### Curing Resin

The resin applied to the fabric is cured.

The resin applied to the fabric may be processed for 100 seconds or less.

### Fiber-Reinforced Composite Material

The fiber-reinforced composite material includes a fabric woven with a warp and a weft, and a resin applied to the fabric.

The warp may include a synthetic fiber, a carbon fiber, or a combination thereof.

The weft may include a synthetic fiber.

The fabric may be woven in any one of a plain weave, a twill weave, or a satin weave.

The synthetic fiber of the warp and/or the weft includes polyethylene terephthalate (PET), nylon, polypropylene (PP), acryl, or any combination thereof.

The resin includes urethane, urethane acrylate, urea, epoxy, acryl, polycarbonate, polymethyl methacrylate, polypropylene, polyvinyl chloride, polyvinyl butyral, or any combination thereof. The resin is applied by impregnating and/or coating the fabric. The cross-section of the synthetic fiber may have at least one shape selected from among a circular shape, an oval shape, a polygonal shape, a flat shape, a multilobal shape, combinations thereof, or other shapes. Here, the aspect ratio of the synthetic fiber may have a flat cross-sectional shape of 1:1.2 to 1:5.

A better understanding may be obtained through the following examples. These examples are merely set forth to illustrate the present disclosure and are not to be construed as limiting the scope of the present disclosure.

### Examples and Comparative Examples

Respective fiber-reinforced composite materials were manufactured using the compositions under the manufacturing conditions set forth in Table 1 below. Here, the manufacturing conditions are as follows.

TABLE 1

| | Composition for fiber-reinforced composite material | | | |
|---|---|---|---|---|
| | Fabric | | | |
| | Warp | Weft | | |
| | (material/ | (material/ | | |
| Category | fineness) | fineness) | Weave | Resin |
| Example 1 | PET/1,500 | PET/1,500 | Twill | Urethane |
| | | | | acrylate |
| Example 2 | PET/1,800 | PET/1,800 | Twill | Urea |
| Example 3 | PET/1,500 | CF/1,800 | Twill | Urethane |
| | | | | acrylate |
| Example 4 | PET/1,800 | PET/1,800 | Plain | Urethane |
| | | | | acrylate |
| Example 5 | CF/1,800 | PET/1,500 | Twill | Urethane |
| | | | | acrylate |
| Example 6 | PET/1,500 | PET/1,500 | Twill | Epoxy |
| Comparative | CF/1,870 | CF/1,870 | Twill | Epoxy |
| Example 1 | | | | |
| Comparative | CF/1,870 | CF/1,870 | Plain | Epoxy |
| Example 2 | | | | |
| Comparative | CF/1,870 | KF/1,600 | Twill | Epoxy |
| Example 3 | | | | |
| Comparative | CF/1,870 | CF(coating)/ | Twill | Epoxy |
| Example 4 | | 1,870 | | |

PET = Polyethylene terephthalate
CF = Carbon fiber
KF = Kevlar Fiber
CF(coating) = Various colors are realized using pigments on surface irregularities in the anodizing process after depositing Al (aluminum) to a thickness of 20 nm to 500 nm on the surface of carbon fiber.

### Test Example 1

The speed at which each of the fabrics in Table 1 was capable of being woven and the speed at which the fabric impregnated with the resin was capable of being cured were measured, and the results thereof are shown in Table 2 below.

TABLE 2

| | Weaving speed | Curing time |
|---|---|---|
| Category | (m/day) | (sec) |
| Example 1 | 600 | 45 |
| Example 2 | 1,000 | 60 |
| Example 3 | 110 | 45 |
| Example 4 | 1,000 | 45 |
| Example 5 | 150 | 45 |
| Example 6 | 600 | 7,200 |
| Comparative Example 1 | 100 | 7,200 |
| Comparative Example 2 | 100 | 7,200 |
| Comparative Example 3 | 100 | 7,200 |
| Comparative Example 4 | 100 | 7,200 |

### Test Example 2

Respective fiber-reinforced composite materials were manufactured under the manufacturing conditions set forth in Table 2 using the fabrics and resins set forth in Table 1, after which the physical properties thereof were measured. The results thereof are shown in Table 3 below.

TABLE 3

| | | | | 3D |
|---|---|---|---|---|
| | | Permeability | Maximum | patterning |
| | Specific | coefficient | shear load | effect |
| Category | gravity | (×10⁻¹⁰ m²) | (N) | (1-5) |
| Example 1 | 1.45 | K₁ 2.90 K₂ 2.74 | 11 | 4 |
| Example 2 | 1.5 | K₁ 3.02 K₂ 2.30 | 21 | 4 |
| Example 3 | 1.45 | K₁ 1.34 K₂ 2.09 | 16 | 5 |
| Example 4 | 1.45 | K₁ 2.87 K₂ 2.22 | 22 | 5 |
| Example 5 | 1.45 | K₁ 2.69 K₂ 0.83 | 19 | 5 |
| Example 6 | 1.45 | K₁ 2.90 K₂ 2.74 | 11 | 4 |
| Comparative | 1.6 | K₁ 1.24 K₂ 0.75 | 38 | 5 |
| Example 1 | | | | |
| Comparative | 1.6 | Ki 1.12 K₂ 0.74 | 50 | 5 |
| Example 2 | | | | |
| Comparative | 1.56 | K₁ 1.09 K₂ 0.76 | 45 | 5 |
| Example 3 | | | | |
| Comparative | 1.6 | K₁ 0.98 K₂ 1.26 | 50 | 4 |
| Example 4 | | | | |

K₁: Resin impregnation coefficient in weft direction
K₂: Resin impregnation coefficient in warp direction
Measurement method
Weaving speed: loom RPM × weaving density (count/inch) × unit time
Curing time: Measurement of the minimum time taken to completely impregnate the fabric with the resin, meaning that there is no unformed portion and there is no deformation during demolding
Permeability coefficient: Measurement according to the method described in Transport in Porous Media 47: 363-380, 2002
Maximum shear load (N): Measurement according to the method described in ASTM D8067 “Standard Test Method for In-Plane Shear Properties of Sandwich Panels Using a Picture Frame Fixture”
3D patterning effect: Visual evaluation by 3 design experts (5: very good, 4: good, 3: fair, 2: poor, 1: none)

As is apparent from the above description, it is possible to provide a method of manufacturing a fiber-reinforced composite material, which is not limited with regard to weaving devices and for which the weaving speed can be increased.

According to the present disclosure, it is possible to provide a fiber-reinforced composite material having a low specific gravity, thereby being capable of lowering the weight of a molded article.

According to the present disclosure, it is possible to provide a fiber-reinforced composite material capable of realizing various colors of fibers.

According to the present disclosure, it is possible to provide a fiber-reinforced composite material that is not limited with regard to the weave pattern of the fabric, regardless of the shape of parts.

The effects of the present disclosure are not limited to the above-mentioned effects. It should be understood that the effects of the present disclosure include all effects that can be inferred from the description of the present disclosure.

What is claimed is:

1. A fiber-reinforced composite material comprising:
a fabric woven having a warp and a weft; and
a resin applied to the fabric,
wherein the warp comprises a synthetic fiber, a carbon fiber, or a combination thereof, and
wherein the weft comprises a synthetic fiber.

2. The fiber-reinforced composite material of claim 1, wherein the fabric comprises a plain fabric, a twill fabric, a satin fabric, or any combination thereof.

3. The fiber-reinforced composite material of claim 1, wherein the synthetic fiber of the warp comprises polyethylene terephthalate (PET), nylon, polypropylene (PP), acryl, or any combination thereof.

4. The fiber-reinforced composite material of claim 1, wherein the synthetic fiber of the weft comprises polyethylene terephthalate (PET), nylon, polypropylene (PP), acryl, or any combination thereof.

5. The fiber-reinforced composite material of claim 1, wherein the resin comprises urethane, urethane acrylate, urea, epoxy, acryl, polycarbonate, polymethyl methacrylate, polypropylene, polyvinyl chloride, polyvinyl butyral, or any combination thereof.

6. The fiber-reinforced composite material of claim 1, wherein the resin has been applied to the fabric by impregnating or coating the fabric.

7. The fiber-reinforced composite material of claim 1, wherein the fabric has a weaving density in a range of 4 to 40 count/inch.

8. The fiber-reinforced composite material of claim 1, wherein a shape of a cross-section of the synthetic fiber of the warp and/or the weft comprises a circular shape, an oval shape, a polygonal shape, a flat shape, a multilobal shape, or any combination thereof.

9. The fiber-reinforced composite material of claim 7, wherein an aspect ratio of the synthetic fiber of the warp and/or the weft having a flat shape of a cross-section is in a range of 1:1.2 to 1:5.

10. A method of manufacturing a fiber-reinforced composite material, the method comprising:
manufacturing a fabric by weaving fibers as a warp and a weft;
applying a resin to the fabric; and
curing the resin applied to the fabric,
wherein the warp comprises a synthetic fiber, a carbon fiber, or a combination thereof, and
wherein the weft comprises a synthetic fiber.

11. The method of claim 10, wherein a weaving speed of the weaving of the fibers is 110 m/day or more.

12. The method of claim 11, wherein the curing of the resin is performed for 100 seconds or less.

13. The method of claim 10, wherein the curing of the resin is performed for 100 seconds or less.

14. The method of claim 10, wherein the synthetic fiber of the warp comprises polyethylene terephthalate (PET), nylon, polypropylene (PP), acryl, or any combination thereof.

15. The method of claim 10, wherein the synthetic fiber of the weft comprises polyethylene terephthalate (PET), nylon, polypropylene (PP), acryl, or any combination thereof.

16. The method of claim 10, wherein the resin comprises urethane, urethane acrylate, urea, epoxy, acryl, polycarbonate, polymethyl methacrylate, polypropylene, polyvinyl chloride, polyvinyl butyral, or any combination thereof.

17. The method of claim 10, wherein the resin is applied to the fabric by impregnating or coating the fabric.

18. The method of claim 10, wherein the fabric has a weaving density in a range of 4 to 40 count/inch.
